(19) United States
(12) Patent Application Publication
(10) Pub. No.: US 2012/0244447 A1
(43) Pub. Date: Sep. 27, 2012

(54) AIR BATTERY

(75) Inventors: Gen Suzuki, Kariya-city (JP); Norikazu Adachi, Nagoya-city (JP); Kenichirou Kami, Takahama-city (JP)

(73) Assignee: DENSO CORPORATION, Kariya-city (JP)

(21) Appl. No.: 13/427,218

(22) Filed: Mar. 22, 2012

(30) Foreign Application Priority Data
Mar. 25, 2011 (JP) 2011-068710

(51) Int. Cl. H01M 8/22

(52) U.S. Cl. 429/405

(57) ABSTRACT

An air battery includes: a positive electrode for utilizing oxygen as active material; a negative electrode for adsorbing and desorbing a metal ion, which includes at least one of Li, Na, K, Ca, Mg, Zn, Fe and Al; and a non-aqueous electrolyte disposed between the positive electrode and the negative electrode. The non-aqueous electrolyte includes ion liquid. When the non-aqueous electrolyte includes the ion liquid, the oxide generated by the discharging step is effectively decomposed. Thus, the battery has excellent cycle characteristics.

### CROSS REFERENCE TO RELATED APPLICATION

This application is based on Japanese Patent Application No. 2011-68710 filed on Mar. 25, 2011, the disclosure of which is incorporated herein by reference.

### TECHNICAL FIELD

The present disclosure relates to an air battery having excellent cycle characteristics.

### BACKGROUND

An air battery utilizes oxygen in atmosphere as a positive-electrode active material. Energy density in the air battery is high. JP-A-2009-32415 teaches a technique for utilizing fluorine containing compound in electrolytic solution in order to increase solubility of oxygen in the electrolytic solution so that output characteristics and a cycle characteristics of the air battery are improved.

The above air battery according to JP-A-2009-32415 has a property capable of charging and discharging at an initial stage. When the charging and discharging steps are repeatedly performed, lithium oxide is formed on a surface of a positive electrode, and the lithium oxide grows to be enlarged. It is difficult to resolve the lithium oxide with using an electric potential. Thus, it is also difficult to perform a charging step as a resolve reaction of the lithium oxide. Accordingly, the air battery does not function as a secondary battery.

### SUMMARY

It is an object of the present disclosure to provide an air battery having excellent cycle characteristics. In the battery, a resolve step for metallic oxide such as lithium oxide formed on the positive electrode is promoted so that the battery has excellent cycle characteristics.

According to an example aspect of the present disclosure, an air battery includes: a positive electrode for utilizing oxygen as active material; a negative electrode for adsorbing and desorbing a metal ion, which includes at least one of Li, Na, K, Ca, Mg, Zn, Fe and Al; and a non-aqueous electrolyte disposed between the positive electrode and the negative electrode. The non-aqueous electrolyte includes ion liquid.

Since the ionic liquid is added into the non-aqueous electrolyte, the oxide generated by the discharge is effectively decomposed, so that cycle characteristic of the battery is improved.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a graph showing a relationship between an additive amount of ionic liquid and current density, which are measured by a cyclic voltammetry method with changing a concentration of ionic liquid, i.e., Py₁₃FSI;

FIG. 2 is a diagram showing a measurement result of the cyclic voltammetry method with various ionic liquid such as Py₁₃FSI and phosphonium ionic liquid; and

FIG. 3 is a diagram showing a measurement result of the cyclic voltammetry method under a condition that the metal oxide is made of Li₂O, and the ionic liquid is Py₁₃FSI.

### DETAILED DESCRIPTION

The present inventors have studied about the air battery. Specifically, when the ion electrolyte is added into the non-aqueous electrolyte, the decomposition of an oxide is facilitated with maintaining the ionic conductivity of the non-aqueous electrolyte. Thus, the battery can be charged with restricting the increase of the solution resistance. Specifically, when the air battery with using the non-aqueous electrolyte includes ionic liquid, the charge to the battery, which causes the decomposition of the oxide, is effectively performed.

In view of the above study, according to an example aspect of the present disclosure, an air battery includes: a positive electrode for utilizing oxygen as active material; a negative electrode for adsorbing and desorbing a metal ion, which includes at least one of Li, Na, K, Ca, Mg, Zn, Fe and Al; and a non-aqueous electrolyte disposed between the positive electrode and the negative electrode. The non-aqueous electrolyte includes ion liquid.

Since the ionic liquid is added into the non-aqueous electrolyte, the oxide generated by the discharge is effectively decomposed, so that cycle characteristic of the battery is improved.

Alternatively, the ion liquid may include at least one of cations, which are imidazolium, pyridinium, ammonium, pyrrolidinium, guanidinium, isouronium, pyrazolium, sulfonium, piperidinium, and thiouronium. Further, the cations may be imidazolium, pyridinium, and pyrrolidinium. Alternatively, the ion liquid may include at least one of anions, which are B(C₂O₄)₂⁻, PF₆⁻, BF₄⁻, Cl⁻, I—, Br⁻, AlCl₄⁻, HCO₃⁻, CF₃SO₃⁻, NO₃⁻, SO₃OH⁻, CF₃CO₂⁻, CH₃OCO₂⁻, CH₃OSO₃⁻, SCN⁻, (SO₂F)₂N⁻, (SO₂CF₃)₂N, (C₂F₅)₃PF₃⁻, CH₃C₆H₄SO₃⁻, C₈H₁₆SO₃⁻, (CN)₂N⁻, C₉H₁₉CO₂⁻, C₄BO₈⁻, N(SO₂CF₃)₂⁻, (CH₃)₂PO₄⁻, (C₂H₅)₂PO₄⁻, C₂H_{S}OSO₃⁻, C₆H₁₃OSO₃⁻, C₄F₉SO₃⁻ and C₈H₁₇OSO₃⁻. In these cases, the decomposition of the oxide is appropriately facilitated.

Alternatively, a concentration of the ion liquid may be in a range between 0.01 mol/L and 1.0 mol/L with respect to the non-aqueous electrolyte as a reference. When the concentration of the ion liquid is equal to or higher than 0.01 mol/L, the decomposition of the oxide is sufficiently facilitated. When the concentration of the ion liquid is equal to or lower than 1.0 mol/L, the non-aqueous electrolyte has sufficient ionic conductivity.

Alternatively, the non-aqueous electrolyte may include at least one of non-aqueous solvents, which are ethylene carbonate, propylene carbonate, butylenes carbonate, gamma-butyrolactone, dimethyl carbonate, ethyl-methyl-carbonate, diethyl carbonate, 1,2-dimethoxyethane, methyl acetate, tetrahydrofuran, 2-methyl-tetrahydrofuran, 1,3-dioxolane, 4-methyl-1,3-dioxolane, diethyl ether, 3-methyl-oxazolidinone, methylsulfolane formic acid, dimethylsulfoxid, and acetonitrile. Alternatively, the non-aqueous electrolyte may include at least one of supporting electrolytes, which are defined as MaXb and Mg(VWXYZ). M represents one of Li, Na, K, Ca, Mg, Zn, Fe, and Al, V represents one of B and Al, X represents one of Br, C₁, PF₆, BF₄, NO₃, AsF₆, ClO₄, CF₃SO₃, N(SO₂CF₃)₂ and N(SO₂CF₂CF₃)₂, a and b represent an integer of 1, 2 or 3, respectively, and W, X, Y and Z represent one of Br, Cl, alkyl group and aryl group, respectively. The alkyl group and aryl group may include CH₃, C₂H₅, C₃H₇ and C₄H₉. In these cases, the non-aqueous electrolyte has excellent performance so that the battery has high performance.

Alternatively, the positive electrode may have a side, which contacts the non-aqueous electrolyte. The positive electrode may have another side, which includes an oxygen permeable film. The oxygen permeable film contacts oxygen containing gas. When the positive electrode includes the oxygen permeable film for supplying oxygen to the positive electrode, which provides to proceed the reaction between the oxygen and the metal ion, the air battery has excellent output characteristic since the oxygen is supplied to the positive electrode sufficiently.

(Air Battery)

An air battery according to an example embodiment includes a positive electrode, a negative electrode and none-aqueous electrolytic solution. The positive electrode promotes a cell reaction with using oxygen as active material. The negative electrode adsorbs and desorbs metal ions. Here, the metal ions are Li ion, Na ion, K ion, Ca ion, Mg ion, Zn ion, Fe ion, or Al ion. The none-aqueous electrolytic solution includes ionic liquid.

A structure of a none-aqueous electrolytic solution battery may be any structure. For example, the positive electrode, the negative electrode and the electrolytic solution are formed to be a sheet, and then, the positive electrode sheet, the negative electrode sheet and the electrolytic solution sheet are stacked and winded so that a winding type battery is formed. Alternatively, the positive electrode sheet, the negative electrode sheet and the electrolytic solution sheet are stacked so that a multi-layer type battery is formed. Further, the shape of the positive electrode, the negative electrode and the electrolytic solution may be any shape. For example, the positive electrode, the negative electrode and the electrolytic solution may be a sheet or a plate. Here, when the positive electrode promotes a cell reaction with using oxygen as active material, oxygen containing gas such as air is supplied to the positive electrode. In the present embodiment, the none-aqueous electrolytic solution battery may be a primary battery or a secondary battery. When the air battery is the secondary battery, the battery promotes the reaction in case of a charging process rather than the reaction in case of a discharging process. Thus, the air battery may be the secondary battery.

The positive electrode includes an electric power collector, a catalyst and a conductive member. The catalyst promotes the reaction with the oxygen at the positive electrode. The catalyst is made of one of or a combination of silver, platinum, iridium oxide, ruthenium oxide, manganese oxide, cobalt oxide, nickel oxide, ferric oxide, copper oxide, and metal phthalocyanine. Alternatively, the catalyst may be radical material having radical in a molecular. The catalyst may be a particle.

The conductive member has conductivity. The conductive member may be made of material having sufficient stability in atmosphere of the battery. For example, the conductive member may be made of carbon. The catalyst is supported on the surface of the conductive member. When the catalyst is supported on the surface of the conductive member, the conductive member may have a large specific surface area so that sufficient reaction space is formed. When the catalyst is made of carbon with a large specific surface area, the catalyst may have porous structure. The carbon with the porous structure is, for example, mesoporous carbon. The carbon without the porous structure is, for example, graphite, acetylene black, carbon nano-tube or carbon fiber.

The electric power collector has electric conductivity. The electric power collector may function as oxygen permeable film for supplying oxygen to the positive electrode. The oxygen permeable film may be an oxygen enrichment film for transmitting oxygen selectively. Alternatively, the oxygen permeable film may be a film made of conventional high polymer material. For example, the oxygen permeable film may be a porous film made of conventional high polymer material. The high polymer material is at least one of polyethylene, polypropylene, poly-4-methyl-1-pentene, poly-3-methyl-1-butene, poly-styrene, poly-methyl-methacrylate, poly-vinyl chloride, nylon-6, nylon-66, poly-vinyl-alcohol, poly-ethylene terephthalate, poly-butylene terephthalate, polyphenylene sulfide, poly-tetrafluoro-ethylene, cellulose acetate, poly-sulfone, poly-carbonate, and poly-imide.

When the oxygen permeable film functions as the electric power collector, i.e., when the oxygen permeable film doubles as the electric power collector, the oxygen permeable film may be made of porous material having a front surface and a back surface, which are communicated with each other and made of conductive material. Specifically, the porous material is stainless steel, nickel, aluminum, copper or the like. Alternatively, the oxygen permeable film may be made of a mesh, punching metal or the like. When the oxygen permeable film is made of porous material, the conductive member, the catalyst or the like may be embedded in a hole of the porous material. Alternatively, the conductive member, the catalyst or the like may be embedded in a hole of the mesh or the punching metal.

The radical material may be stably disposed in the atmosphere of the battery. The radical material may be a compound having a radical framework. A chemical structure other than the radical framework may mutually and electronically interact with a radical. Alternatively, the chemical structure other than the radical framework may not mutually and electronically interact with a radical. For example, the radical framework may be coupled with high polymer compound.

The radical framework is, for example, a framework having nitroxyl radical, a framework having oxy radical, a framework having nitrogen radical, a framework having sulfur radical, a framework having carbon radical, or a framework having boron radical. Specifically, the radical material is 2,2,6,6-tetra methyl-1-piperidinyloxy (i.e., TEMPO), 4-hydroxy-2,2,6,6-tetramethyl-piperidinyloxy (i.e., TEMPO-OH), 3-carbamoyl-2,2,5,5-tetramethyl-pyrrolidine-1-yloxy (i.e., 3-carbamoyl-PROXYL), or 3-carboxy-2,2,5,5-tetramethyl-1-pyrrolidinyloxy (i.e., 3-carboxy-PROXYL).

The positive electrode may include binding material. The binding material fixes the conductive member and the catalyst in the electric power collector. The binding material may be any material. For example, the binding material is thermoplastic resin or thermosetting resin. Specifically, the binding material is poly-ethylene, poly-propylene, poly-tetrafluoroethylene (i.e., PTFE), polyvinylidene fluoride (i.e., PVDF), styrene butadiene rubber, tetrafluoroethylene hexafluoroethylene copolymer, tetrafluoroethylene hexafluoropropylene copolymer (i.e., FEP), tetrafluoroethylene perfluoro alkyl vinyl ether copolymer (i.e., PFA), vinylidene fluoride hexafluoropropylene copolymer, vinylidene fluoride chlorotrifluoroethylene copolymer, ethylene tetrafluoroethylene copolymer (i.e., ETFE), poly-chlorotrifluoroethylene (i.e., PCTFE), vinylidene fluoride pentafluoropropylene copolymer, propylene tetrafluoroethylene copolymer, ethylene chlorotrifluoroethylene copolymer (i.e., ECTFE), vinylidene fluoride hexafluoropropylene tetrafluoroethylene copolymer, vinylidene fluoride perfluoro methyl vinyl ether tetrafluoroethylene copolymer, ethylene acrylic acid copolymer or the like. These materials may be used as the binding material individually. Alternatively, a combination of these materials may be used as the binding material.

The positive electrode may be formed by press-forming to the electric power collector after the catalyst, the conductive member and the binding material are mixed if necessary. The electric power collector may have a porous body such as a grid porous body and a mesh porous body in order to promote the diffusion of oxygen. Alternatively, the electric power collector may be a porous metal plate made of stainless steel, nickel, aluminum or copper. The electric power collector may be coated with a metal film or an alloy film having oxidation resistance so that the electric power collector is protected from oxidation.

The negative electrode is made of negative-electrode active material, which adsorbs and desorbs a metal ion and/or deposits and dissolves a metal ion. Alternatively, the negative electrode may include negative-electrode active material. The negative electrode may include an electric power collector. The negative electrode electric power collector may have a punched metal structure, a foam metal structure, a plate shape or a film shape, which are made of copper or nickel. Alternatively, the negative electrode electric power collector may double as a battery casing.

The negative-electrode active material is one of or more negative electrode materials, which include metal material capable of adsorbing and desorbing and/or depositing and dissolving metallic lithium, lithium alloy and lithium, alloy material capable of adsorbing and desorbing and/or depositing and dissolving lithium, and a compound capable of adsorbing and desorbing and/or depositing and dissolving lithium. The alloy material may be made of only metals. Alternatively, the alloy material may be alloy of metal and semi-metal.

The texture of the alloy material includes one of or a combination of solid solution, eutectic alloy (i.e., eutectic mixture), and metallic compound.

A metallic element and a semi-metallic element in the metallic material and the alloy material are tin (Sn), lead (Pb), aluminum (Al), indium (In), silicon (Si), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y) or hafnium (Hf). The alloy material or the compound may be presented by a chemical formula of Ma_{f}Mb_{g}Liₕ or MaₛMcₜMdᵤ. In these chemical formulas, Ma represents at least one of metal elements and semi-metal elements, which can form alloy with lithium. Mb represents at least one of metal elements and semi-metal elements other than lithium and Ma. Mc represents at least one of nonmetal elements. Md represents at least one of metal elements and semi-metal elements other than Ma. The suffixes f, g, h, s, t and u satisfy the equations of f>0, g>=0, h>=0, s>0, t>0, and u>=0.

Specifically, the metallic material and the alloy material may be simple substance, alloy or compound made of metal element or semi-metal element in a group IV-B on the Short Format u Periodical Table of elements. More specifically, the metallic material and the alloy material may be made of silicon or tin, or alloy or a compound of silicon and tin. The metallic material and the alloy material may be crystal or amorphous.

The negative electrode material capable of adsorbing and desorbing and/or depositing and dissolving lithium may be oxide, sulfide, or other metal compound such as lithium nitride. The lithium nitride is, for example, LiN₃. The oxide is, for example, MnO₂, V₂O₅, V₆O₁₃, NiS or MoS. Alternatively, the oxide capable of adsorbing and desorbing and/or depositing and dissolving lithium having comparatively small potential may be ferric oxide, ruthenium oxide, molybdenum oxide, tungsten oxide, titanium oxide, tin oxide or the like. The sulfide may be NiS, MoS or the like.

The negative electrode active material may be used alone. Alternatively, the negative electrode active material may be used together with other necessary elements. Here, the other necessary elements include, for example, binding material. The binding material functions to bond elements in the negative electrode, and an element in the negative electrode and the negative electrode electric power collector. The binding material may be organic binding material, or inorganic binding material. The binding material in the negative electrode is thermoplastic resin or thermosetting resin. Specifically, the binding material is PTFE, PVDF, styrene butadiene rubber, tetrafluoroethylene hexafluoroethylene copolymer, FEP, PFA, vinylidene fluoride hexafluoropropylene copolymer, vinylidene fluoride chlorotrifluoroethylene copolymer, ETFE, PCTFE, vinylidene fluoride pentafluoropropylene copolymer, propylene tetrafluoroethylene copolymer, ECTFE, vinylidene fluoride hexafluoropropylene tetrafluoroethylene copolymer, vinylidene fluoride perfluoro methyl vinyl ether tetrafluoroethylene copolymer, ethylene acrylic acid copolymer or the like. These materials may be used as the binding material individually. Alternatively, a combination of these materials may be used as the binding material. Specifically, the binding material may be PVDF, polyvinylidene chloride, PTFE or CMC.

The none-aqueous electrolytic solution provides to conduct a metal ion. For example, the none-aqueous electrolytic solution may be made of none-aqueous solution with supporting salt solved in the none-aqueous solution. The none-aqueous electrolytic solution includes ionic liquid. The none-aqueous electrolytic solution is disposed between the positive electrode and the negative electrode so that the none-aqueous electrolytic solution provides medium for conducting the metal ion between the positive electrode and the negative electrode.

The ionic liquid may be any liquid as long as the ionic liquid alone is in a liquid state in an operating temperature range of the battery. For example, the ionic liquid may include cation, which is one of or a combination of imidazolium, pyridinium, phosphonium, ammonium, pyrrolidinium, guanidinium, isouronium, pyrazolium, sulfonium, piperidinium, and thiouronium. Specifically, the ionic liquid may include cation, which is one of or a combination of imidazolium, pyridinium and pyrrolidinium. More specifically, the cation may be 1-methyl-propylpiperidinium, 1,1,1-trimethyl-1-ammonium, 1-methyl-1-propylpyrrolidinium, and/or 1-methyl-1-butylpyrrolidinium.

Further, the ionic liquid may include anion, which is one of or a combination of B(C₂O₄)₂⁻, PF₆⁻, BF₄⁻, Cl⁻, Br⁻, AlCl₄⁻, HCO₃⁻, CF₃SO₃⁻, NO₃⁻, SO₃OH⁻, CF₃CO₂⁻, CH₃OCO₂⁻, CH₃OSO₃⁻, SCN⁻, (SO₂F)₂N⁻, (SO₂CF₃)₂N⁻, (C₂F₅)₃PF₃⁻, CH₃C₆H₄SO₃⁻, C₈H₁₆SO₃⁻, (CN)₂N⁻, C₉H₁₉CO₂⁻, C₄BO₈⁻, N(SO₂CF₃)₂⁻, (CH₃)₂PO₄⁻, (C₂H₅)₂PO₄⁻, C₂H₅OSO₃⁻, C₆H₁₃OSO₃⁻, C₄F₉SO₃⁻ and C₈H₁₇OSO₃⁻. Specifically, the anion may be (SO₂F)₂N⁻ (i.e., FSI or bis(fluorosulfonyl)imide) or (SO₂CF₃)2N⁻ (i.e., TFSI or bis(trifluoromethanesulfonyl)imide).

The concentration of the ionic liquid as additive may be equal to or larger than 0.01 mol/L with regard to a whole of the none-aqueous electrolytic solution as standard. Specifically, the concentration of the ionic liquid as additive may be equal to or larger than 0.06 mol/L. Further, the concentration of the ionic liquid as additive may be equal to or smaller than 1 mol/L. Specifically, the concentration of the ionic liquid as additive may be equal to or smaller than 0.44 mol/L. When the concentration of the ionic liquid as additive is equal to or larger than 0.01 mol/L, decomposition of oxide is sufficiently performed. When the concentration of the ionic liquid as additive is equal to or smaller than 1 mol/L, the none-aqueous electrolytic solution has sufficient ionic conductivity.

The non-aqueous solution may be aprotic organic solvent. Specifically, the non-aqueous solution may be one of or a combination of cyclic carbonate, chain carbonate, cyclic ester, cyclic ether, and chain ether. The cyclic carbonate may be ethylene carbonate (i.e., EC), propylene carbonate, butylenes carbonate, or vinylene carbonate. The chain carbonate may be dimethyl carbonate (i.e., DMC), diethyl carbonate, or ethyl-methyl-carbonate (i.e., EMC). The cyclic ester carbonate may be gamma-butyrolactone, gamma-Valerolactone or the like. The cyclic ether may be tetrahydrofuran, 2-methyl-tetrahydrofuran or the like. The chain ether may be dimethoxyethane, ethylene glycol dimethyl ether or the like. These materials may be used alone for the non-aqueous solution. Alternatively, a combination of these materials may be used for the non-aqueous solution.

Specifically, the non-aqueous solution may be one of or a combination of non-aqueous solvents, which include ethylene carbonate, propylene carbonate, butylenes carbonate, gamma-butyrolactone, dimethyl carbonate, diethyl carbonate, ethyl-methyl-carbonate, diethyl carbonate, 1,2-dimethoxyethane, methyl acetate, tetrahydrofuran, 2-methyl-tetrahydrofuran, 1,3-dioxolane, 4-methyl-1,3-dioxolane, diethyl ether, 3-methyl-oxazolidinone, methylsulfolane formic acid, dimethylsulfoxid, and acetonitrile.

A supporting electrolyte as a supporting salt may include a metal ion corresponding to a metal ion for desorbing from or adsorbing on and/or depositing on or dissolving on positive and negative electrodes. For example, the supporting electrolyte may be one of or a combination of supporting electrolytes, which includes MaXb and Mg(VWXYZ). Here, M represents one of Li, Na, K, Ca, Mg, Zn, Fe, and Al. V represents one of B and Al. Further, X represents Br, C₁, PF₆, BF₄, NO₃, AsF₆, ClO₄, CF₃SO₃, N(SO₂CF₃)₂ and N(SO₂CF₂CF₃)₂, and a and b represent an integer in a range between 1 and 3. Here, W, X, Y and Z represent Br, Cl, alkyl group and aryl group. The alkyl group and the aryl group may include CH₃, C₂H₅, C₃H₇ and C₄H₉.

The concentration of the supporting electrolyte may be in a range between 0.1M and 2.0M. Alternatively, the concentration of the supporting electrolyte may be in a range between 0.8M and 1.2M.

The battery may include a separator disposed between the positive electrode and the negative electrode and a battery casing for accommodating the positive and negative electrodes and non-aqueous electrolyte. The separator may be made of a porous film or a nonwoven material, which stably exists under atmosphere in the battery. For example, the separator may be made of polyolefin or polyester. The battery casing may be made of material, which exists stably under atmosphere in the battery. As described above, the battery casing may function as the electric power collector of the positive electrode and/or the negative electrode. Alternatively, the battery casing may function as a terminal for transmitting electricity to and receiving electricity from an external device.

The air battery according to an example embodiment will be explained. A cyclic voltamo-gram is measured by a cyclic voltammetry method with using metal oxide as a working electrode, which is generated by battery reaction of the air battery. The ion liquid is added into the non-aqueous electrolyte sufficiently so that oxidation-reduction reaction of the metal oxide is evaluated in various additive amount of the ion liquid, various types of the ion liquid, and various types of the working electrode.

(Preparation of Working Electrode)

The working electrode is made of MgO as the metal oxide. Specifically, the powder of the metal oxide and the powder of PTFE (polytetrafluoroethylene) are mixed with a weight ratio between the metal oxide and the PTFE of 9:1. The mixture is performed in a mortar so that the mixed material is prepared. Then, the mixed material is pressed on a mesh made of nickel. Then, the mixed material is dried at 60 degrees C. for twenty minutes. Then, a lead made of nickel is welded to the mixed material by a welding method. Then, the material is dried at 120 degrees C. for one hour. Then, the material is covered with a masking tape to expose a square area of 5 millimeter square so that an exposed area is defined in the working electrode.

Further, the metal oxide made of Li₂O is also prepared, and the working electrode is formed. In this case, the powder of the Li₂O and the powder of PTFE (polytetrafluoroethylene) are mixed with a weight ratio between the metal oxide and the PTFE of 9:1. The mixture is performed in a mortar so that the mixed material is prepared. Then, the mixed material is pressed on a mesh made of nickel. Then, the mixed material is dried at 60 degrees C. for twenty minutes. Then, a lead made of nickel is welded to the mixed material by a welding method. Then, the material is dried at 120 degrees C. for one hour. Then, the material is covered with a masking tape to expose a square area of 5 millimeter square so that an exposed area is defined in the working electrode.

(Cyclic Voltammetry)

<MgO>

When the metal oxide is made of MgO, the non-aqueous electrolyte is prepared such that the supporting electrolyte made of Mg(TFSI)₂ is used with the concentration of 1M, the non-aqueous is prepared by mixing the PC and the DMC with a volume ratio of 1:1, and the ion liquid is solved into mixing solvent with the later described concentration. The ion liquid is made of 1-methyl-1-propyl-pyrrolidinium bis(fluorosulfonyl)imide (i.e., Py₁₃FSI). The concentration of the ion liquid is 0.05M, 0.1M, 0.5M and 1M. Further, another ion liquid is prepared with using tetra-decyl-trihexyl-phosphonium bis(tri-fluoro-methyl-sulfonyl)imide (i.e., phosphonium type ion liquid) with the concentration of 1M.

The condition of the cyclic voltammetry method is such that the scanning voltage range is from 0 volt to 4 volts, and the scanning speed is 10 mV/s at 0V.

<Li₂O>

When the metal oxide of the working electrode is made of Li₂O, the non-aqueous electrolyte is prepared such that the supporting electrolyte made of LiPF₆ is used with the concentration of 1M, the non-aqueous is prepared by mixing the PC, DMC and EMC with a volume ratio of 30:30:40, and the ion liquid is solved into mixing solvent with the concentration of 1M. The ion liquid is made of 1-methyl-1-propyl-pyrrolidinium bis(fluorosulfonyl)imide (i.e., Py₁₃FSI).

The condition of the cyclic voltammetry method is such that the scanning voltage range is from 0 volt to 4 volts, and the scanning speed is 10 mV/s at 0V.

<Results>

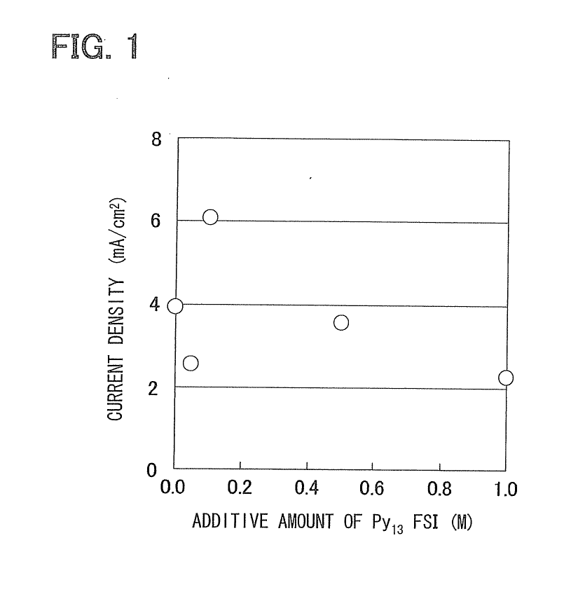

The results will be shown in FIGS. 1 to 3. In view of the relationship between the additive amount of the Py₁₃FSI and the current density shown in FIG. 1, the current density, which shows the decomposition of MgO, increases when the Py₁₃FSI is added in a certain additive amount range. The appropriate additive amount of the Py₁₃FSI is the concentration of 0.1M. In this case, the current density increases by 54 percentages. Accordingly, the appropriate additive concentration of the Py₁₃FSI is larger than 0.06M and smaller than 0.44M.

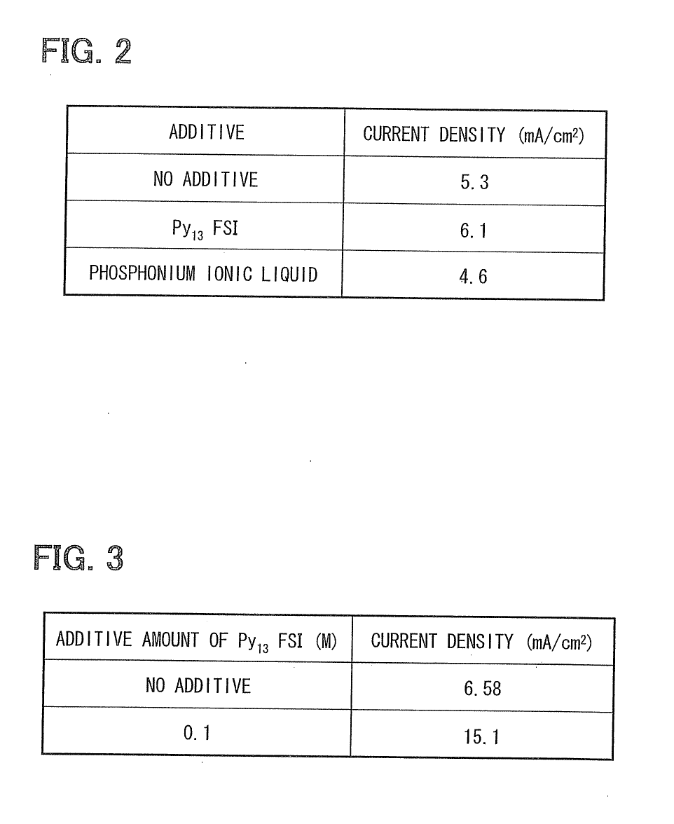

As shown in FIG. 2, the current density in a system with using the non-aqueous electrolyte, in which the Py₁₃FSI is added, is larger than in a system with using he non-aqueous electrolyte, in which the phosphonium type ion liquid is added. Accordingly, when the ion liquid is the pyrrolidinium type liquid such as the Py₁₃FSI, the current density is large.

As shown in FIG. 3, even when the metal oxide is made of Li₂O, the current density increases in a case where the Py₁₃FSI is added. In this case, the decomposition speed of the Li₂O increases. Thus, the metal oxide is made of not only MgO but also Li₂O, the current density increases. Further, since the large effects are obtained in each of a case with using Mg and a case with using Li, which are largely different from each other, the decomposition promotion is obtained regardless of the type of metal in the metal oxide.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An air battery comprising:
a positive electrode for utilizing oxygen as active material;
a negative electrode for at least adsorbing and desorbing, or depositing and dissolving a metal ion, which includes at least one of Li, Na, K, Ca, Mg, Zn, Fe and Al; and
a non-aqueous electrolyte disposed between the positive electrode and the negative electrode,
wherein the non-aqueous electrolyte includes ion liquid.

2. The air battery according to claim 1,
wherein the ion liquid includes at least one of cations, which are imidazolium, pyridinium, ammonium, pyrrolidinium, guanidinium, isouronium, pyrazolium, sulfonium, piperidinium, and thiouronium.

3. The air battery according to claim 2,
wherein the cations are imidazolium, pyridinium, and pyrrolidinium.

4. The air battery according to claim 1,
wherein the ion liquid includes at least one of anions, which are B(C₂O₄)₂⁻, PF₆⁻, BF₄⁻, Cl⁻, I—, Br⁻, AlCl₄⁻, HCO₃⁻, CF₃SO₃⁻, NO₃⁻, SO₃OH⁻, CF₃CO₂⁻, CH₃OCO₂⁻, CH₃OSO₃⁻, SCN⁻, (SO₂F)₂N⁻, (SO₂CF₃)₂N⁻, (C₂F₅)₃PF₃⁻, CH₃C₆H₄SO₃⁻, C₈H₁₆SO₃⁻, (CN)₂N⁻, C₉H₁₉CO₂⁻, C₄BO₈⁻, N(SO₂CF₃)₂⁻, (CH₃)₂PO₄⁻, (C₂H₅)₂PO₄⁻, C₂H₅OSO₃⁻, C₆H₁₃OSO₃⁻, C₄F₉SO₃⁻ and C₈H₁₇OSO₃⁻.

5. The air battery according to claim 1,
wherein a concentration of the ion liquid is in a range between 0.01 mol/L and 1.0 mol/L with respect to the non-aqueous electrolyte as a reference.

6. The air battery according to claim 1,
wherein the non-aqueous electrolyte includes at least one of non-aqueous solvents, which are ethylene carbonate, propylene carbonate, butylenes carbonate, gamma-butyrolactone, dimethyl carbonate, ethyl-methyl-carbonate, diethyl carbonate, 1,2-dimethoxyethane, methyl acetate, tetrahydrofuran, 2-methyl-tetrahydrofuran, 1,3-dioxolane, 4-methyl-1,3-dioxolane, diethyl ether, 3-methyl-oxazolidinone, methylsulfolane formic acid, dimethylsulfoxid, and acetonitrile.

7. The air battery according to claim 1,
wherein the non-aqueous electrolyte includes at least one of supporting electrolytes, which are defined as MaXb and Mg(VWXYZ),
wherein M represents one of Li, Na, K, Ca, Mg, Zn, Fe, and Al,
wherein V represents one of B and Al,
wherein X represents one of Br, Cl, PF₆, BF₄, NO₃, AsF₆, ClO₄, CF₃SO₃, N(SO₂CF₃)₂ and N(SO₂CF₂CF₃)₂,
wherein a and b represent an integer of 1, 2 or 3, respectively, and
wherein W, X, Y and Z represent one of Br, Cl, CH₃, C₂H₅, C₃H₇ and C₄H₉, respectively.

8. The air battery according to claim 1,
wherein the positive electrode has a side, which contacts the non-aqueous electrolyte,
wherein the positive electrode has another side, which includes an oxygen permeable film, and
wherein the oxygen permeable film contacts oxygen containing gas.

9. The air battery according to claim 1,
wherein the negative electrode adsorbs and desorbs, and deposits and dissolves the metal ion.
